(19) United States
(12) Patent Application Publication
(10) Pub. No.: US 2022/0412915 A1
(43) Pub. Date: Dec. 29, 2022

(54) METHOD FOR PRODUCING A POLYMER MEMBRANE FOR POTENTIOMETRIC DETECTION OF AN ANALYTE PRESENT IN A FLUID

(71) Applicants: COMMISSARIATÀ L'ÉNERGIE ATOMIQUE ET AUX ÉNERGIES ALTERNATIVES, Paris (FR); CARDIORENAL, Strasbourg (FR)

(72) Inventors: Mélanie Alias, Grenoble (FR); Maxime Gougis, Grenoble (FR); Guilhem Henrion, Paris (FR); Pascal Mailley, Grenoble (FR); Thibault Thery-Parriel, Grenoble (FR); Yohann Thomas, Grenoble (FR)

(21) Appl. No.: 17/756,065

(22) PCT Filed: Nov. 17, 2020
(86) PCT No.: PCT/FR2020/052102

§ 371 Date: May 16, 2022

(30) Foreign Application Priority Data
Nov. 18, 2019 (FR) 1912819

(51) Int. Cl. G01N 27/333; G01N 27/30

(52) U.S. Cl. CPC G01N 27/3335; G01N 27/301

(57) ABSTRACT

A method for producing a polymer membrane for the potentiometric detection of an analyte, the method comprising the following successive steps: providing a formulation comprising a dissolved polymer, an ion exchanger, an ionophore, optionally a plasticiser, and a solvent selected from glycol ethers and acetates thereof, and glycol diacetates, depositing the formulation on a support, for example a transducer, and evaporating the solvent, so as to form a polymer membrane.

### TECHNICAL FIELD

The present invention relates to the general field of polymer membranes for the potentiometric detection of an analyte present in a fluid, and more particularly in a body fluid.

The invention relates to a method for producing such a polymer membrane.

The invention also relates to such a polymer membrane.

The invention also relates to a method for producing a working electrode comprising such a polymer membrane.

The invention can be applied in many industrial fields, in particular in the production of electrochemical sensors, for example for determining the concentration of potassium in the blood.

### PRIOR ART

Currently, the concentration of potassium in the blood is measured with an electrochemical sensor by potentiometry.

The sensor consists of a current collector (electrically conductive tracks), a transducer (for example a layer of carbon for converting the activity of a dissolved ion into electrical potential) and a solid ion selective membrane referred to as ISE (Ion Selective Electrode).

The ISE membrane is in contact with the fluid to be analysed and allows the transport of the target ion to the transducer to be analysed.

Generally, the ISE membrane is obtained from a solution comprising:
a hydrophobic polymer used as a mechanical base for the membrane, and limiting the penetration of water,
a plasticiser for increasing the mobility of polymer chains and obtaining better conduction of ions within the membrane,
an ion exchanger for better signal transduction,
a solvent.

Since the 1960s the vast majority of sensors developed have an ISE membrane based on polyvinyl chloride (PVC). However, as this polymer is not totally inert and not totally hydrophobic, polyurethane (PU) has increasingly replaced PVC.

In the article by Cuartero et al. (“Polyurethane Ionophore-Based Thin Layer Membranes for Voltammetric Ion Activity Sensing”, Anal. Chem. 2016, 88, 5649-5654), the properties of different polyurethane, polystyrene, polyacrylate and PVC membranes were compared. To produce the membranes, the different constituents of the membranes are dissolved in THF, then the solution is deposited by spinning deposition. The mechanical, physical and/or chemical resistance properties of membranes made with PU are better than those made with other polymers.

The article by Yun et al. (“Potentiometric Properties of Ion-Selective Electrode Membranes Based on Segmented Polyether Urethane Matrices”, Anal. Chem. 1997, 69, 868-873) also describes the development of ISE membranes made of PU from a solution based on THF alone, a mixture of THF with dimethylformamide (DMF) or DMF alone. Potassium-selective membranes have been made from these PU and valinomycin matrices.

In document WO 91/17432 A1, membranes based on a matrix of PVC, PU or a PVC/Ac/Al copolymer are obtained by dissolving its different constituents in THF. The polyurethane-based membranes have electrochemical qualities similar to those made of PVC. The copolymer membranes have very good adhesion to a glass or Si₃N₄ substrate. These membranes are used in particular to form a potassium-selective membrane.

The solvent used to make these different membranes is almost exclusively tetrahydrofuran (THF). This solvent is an extremely volatile, flammable and highly toxic compound. It is classified as CMR (carcinogenic, mutagenic and reprotoxic). The implementation of the method with such a solvent therefore requires specific conditions, in particular with regard to environmental and safety risks, which makes the method difficult to industrialise.

### PRESENTATION OF THE INVENTION

An aim of the present invention is to propose a method for producing an ISE type membrane which limits or eliminates the use of THF and makes it possible to obtain reliable and robust membranes.

To achieve this, the present invention proposes a method for producing a polymer membrane for the potentiometric detection of an analyte, the method comprising the following successive steps:
providing a formulation comprising a dissolved polymer, an ion exchanger, an ionophore, optionally a plasticiser, and a solvent selected from glycol ethers and acetates thereof, and alkylene glycol diacetates,
depositing the formulation on a support, for example a transducer,
evaporating the solvent, so as to form a polymer membrane.

The invention differs fundamentally from the prior art in the use of a solvent selected from a glycol ether, a glycol ether acetate or an alkylene glycol diacetate. Such solvents are less toxic and less volatile than THF, which makes the production of potentiometric sensors less restrictive in terms of the safety precautions relating to environmental risks and with regard to the safety of people implementing the process, and/or with regard to the flammability risk of the solvents. Furthermore, as these solvents evaporate more slowly than THF, the deposit obtained is more homogenous and covers the support surface better.

Advantageously, the solvent is selected from ethylene glycol monoalkyl acetates, diethylene glycol monoalkyl ether acetates, ethylene glycol dialkyl ether acetates, and diethylene glycol dialkyl ether acetates.

Advantageously, the solvent is diethylene glycol monoethyl ether acetate.

Advantageously, the solvent is selected from ethylene glycol diacetate and diethylene glycol diacetate.

Advantageously, the formulation comprises an additional solvent whereby a mixture of solvents is formed, the additional solvent being less than 50% by volume of the mixture of solvents.

Advantageously, the ionophore and the ion exchanger are selective for potassium ions.

According to a first advantageous embodiment, the polymer is selected from vinyl polymers, polysiloxanes, polystyrenes, cellulose acetate, poly(vinylpyrrolidinone) copolymers such as poly(vinyl pyrrolidone-co-vinyl acetate), (meth)acrylates such as decyl methacrylate-hexanediol dimethacrylate and polymethylmethacrylate.

According to another particularly advantageous embodiment the polymer is a polyurethane.

The invention also relates to a formulation for producing a polymer membrane for the potentiometric detection of an analyte, the formulation comprising a dissolved polymer, an ion exchanger, an ionophore, optionally a plasticiser, and a solvent selected from glycol ethers and their acetates, and alkylene glycol diacetates.

The invention also relates to a polymer membrane for the potentiometric detection of an analyte, obtained by the method as defined above, comprising a polymer, an ion exchanger, an ionophore, optionally a plasticiser, and traces of a solvent selected from glycol ethers and acetates thereof, and alkylene glycol diacetates. Traces of solvent are defined as less than 5% by mass of solvent.

Advantageously, the polymer is a polyurethane.

The invention also relates to a method for producing a working electrode comprising the following successive steps:
providing a formulation comprising a dissolved polymer, an ion exchanger, an ionophore, optionally a plasticiser, and a solvent selected from glycol ethers and acetates thereof, and alkylene glycol diacetates,
providing a substrate, covered successively by a current collector and by a transducer,
depositing the formulation on the transducer,
evaporating the solvent, in order to form a polymer membrane.

Advantageously, the transducer is obtained by depositing on the current collector a solution containing a carbonaceous material and a solvent selected from glycol ethers and acetates thereof, and alkylene glycol diacetates.

Advantageously, the solvent of the formulation and the solvent of the solution are identical, which makes it possible to improve the ISE membrane/transducer interface.

Other features and advantages of the invention will be given in the following description.

It goes without saying that this further description is given only as an illustration of the subject-matter of the invention and should in no way be construed as a limitation of this subject-matter.

### BRIEF DESCRIPTION OF THE DRAWINGS

The present invention is explained further in the following description of embodiments given purely by way of example and without limitation with reference to the accompanying drawings in which:

FIG. 1 shows in cross-section and in profile a working electrode comprising a polymer membrane, deposited on a substrate, according to a particular embodiment of the invention,

FIG. 2 is a graph representing the potential as a function of time during the calibration of three working electrodes, each comprising a polymer membrane obtained from a formulation containing THF,

FIG. 3 is a graph representing the potential as a function of time during the calibration of three working electrodes, each comprising a polymer membrane obtained from a formulation according to a particular embodiment of the invention,

FIG. 4 is a graph representing the potential as a function of concentration, obtained from the calibration curve of FIG. 2,

FIG. 5 is a graph representing the potential as a function of concentration, obtained from the calibration curve of FIG. 3,

FIG. 6 is a curve representing the derivatives of the potential as a function of the concentration of potassium, for an electrode whose polymer membrane has been obtained from a formulation containing THF (referenced CE-1) and for an electrode whose polymer membrane has been obtained from a formulation according to a particular embodiment of the invention (referenced INV-1),

FIG. 7 is a graph representing the potential as a function of time and different concentrations during the calibration of three working electrodes, each comprising a polymer membrane obtained from different formulations according to different particular embodiments of the invention.

The different parts represented in the figures are not necessarily shown using a uniform scale to make the figures easier to read.

The different possibilities (variants and embodiments) should be interpreted as not being exclusive of one another and can be combined with one another.

Furthermore, in the following description, terms which relate to the orientation, such as “top”, “bottom” etc. of a structure are used assuming that the structure is oriented as shown in the figures.

### DETAILED PRESENTATION OF PARTICULAR EMBODIMENTS

In the following, where the description refers to a polymer membrane 10 for the selective potentiometric detection of an analyte in ionic form in the blood, the invention can be applied to any other body fluid, such as sweat, saliva, tears, urine or even plasma, or in a general manner to any other fluid containing an analyte to be detected. The analyte can be a potassium, sodium, magnesium, iron, calcium, lithium, chlorine or even hydrogen ion.

The polymer membrane 10 is obtained according to a method including the following successive steps:

a) providing a formulation comprising a dissolved polymer, an ion exchanger, an ionophore, optionally a plasticiser, and at least one solvent selected from glycol ethers, glycol ether acetates or alkylene glycol diacetates,

b) depositing the formulation on a support, for example a transducer,

c) evaporating the solvent, so as to form a polymer membrane.

The formulation provided in step a) comprises at least one glycol ether, glycol ether acetate or an alkylene glycol diacetate.

For example, the glycol ether is selected from:
ethylene glycol monoalkyl ethers, such as ethylene glycol monoethyl ether (CAS 110-80-5), ethylene glycol monopropyl ether (CAS 2807-30-9) and ethylene glycol monomethyl ether (CAS 109-86-4),
ethylene glycol dialkyl ethers, such ethylene glycol diethyl ether (CAS 629-14-1), ethylene glycol dibutyl ether (CAS 112-48-1) and ethylene glycol dimethyl ether (CAS 110-71-4),
diethylene glycol monoalkyl ethers, such as diethylene glycol monoethyl ether (CAS 111-90-0 also referred to as diethylene glycol ethyl ether) and diethylene glycol monomethyl ether (CAS 111-77-3),
diethylene glycol dialkyl ethers, such as diethylene glycol diethyl ether (CAS 112-36-7).

The alkylene glycol diacetate is for example selected from ethylene glycol diacetate (CAS 111-55-7, EGDA), diethylene glycol diacetate (CAS 628-68-2, DGDA) and propylene glycol diacetate (CAS 623-84-7).

Preferably, the solvent is selected from glycol ether acetates, regrouping the ethylene glycol ether acetates and propylene glycol ether acetates.

The propylene glycol ether acetate is for example a propylene glycol monoalkyl ether acetate, such as propylene glycol monomethyl ether acetate (CAS 108-65-6).

Preferably, the solvent is selected from ethylene glycol ether acetates and from diethylene glycol ether acetates. By way of illustration a selection is made advantageously from:
ethylene glycol monoalkyl ether acetates such as ethylene glycol monoethyl ether acetate (CAS 111-15-9, also referred to as 2-ethoxyethyl acetate), ethylene glycol monomethyl ether acetate (CAS 110-49-6, also referred to as EGMEA), ethylene glycol monopropyl ether acetate (CAS 20706-25-6) and ethylene glycol monobutyl ether acetate (CAS 112-07-2),
diethylene glycol monoalkyl ether acetates such as diethylene glycol monoethyl ether acetate (CAS 112-15-2, DGMEA), and diethylene glycol monomethyl ether acetate,
ethylene glycol dialkyl ether acetates,
diethylene glycol dioalkyl ether acetates, such diethylene glycol dimethyl ether acetate.

The solvent can be used alone or in a mixture.

According to a first embodiment, a mixture is selected comprising and preferably consisting of one or more solvents from glycol ethers, glycol ether acetates, and glycol alkylene diacetates, mentioned above.

According to a further embodiment, a mixture of solvent is selected comprising and preferably consisting of a glycol ether, a glycol ether acetate and/or a glycol alkylene diacetate and an additional solvent. The additional solvent represents preferably less than 50% by volume, and more preferably less than 20% by volume of the mixture of solvents. The additional solvent can be THF.

The polymer of the formulation is advantageously a hydrophobic polymer. In particular, the polymer can be selected from vinyl polymers, polysiloxanes (silicone rubber), polyurethanes, polystyrenes, cellulose acetate, copolymers of poly(vinylpyrrolidinone) (PVP) such as poly(vinyl pyrrolidone-co-vinyl acetate), (meth)acrylates such as decyl methacrylate-hexanediol dimethacrylate and polymethylmethacrylate. It is also possible to select a copolymer thereof.

The polymer of the formulation is preferably a polyurethane.

The plasticiser is for example selected from: 2-nitrophenyl octyl ether (NPOE), bis (2-ethylhexyl) sebacate (DOS), dioctyl phthalate (DOP), dibutyl phthalate (DBP), bis(butylpentyl)adipate (BBPA), didecyl phthalate, dioctyl phenyl phosphonate, dioctyl azelate (DOZ), dioctyl adipate (DOA), tris(2-ethylhexyl)phosphate (TEHP), chloroalkanes (chlorinated paraffins).

Certain polymers or copolymers do not require plasticising to form an ISE, for example the copolymer of PMMA/PDMA.

The selection of the ionophore and exchanger depends on the analyte to be detected. It makes it possible to selectively detect the analyte of interest.

By way of illustration and without limitation, the ion exchanger can be selected from potassium tetrakis(4-chlorophenyl)borate, sodium tetrakis(4-chlorophenyl)borate, potassium tetrakis[3,5-bis(trifluoromethyl)phenyl]borate, sodium tetrakis[3,5-bis(trifluoromethyl)phenyl]borate.

By way of illustration and without limitation, the ionophore can be selected from: valinomycin, nigericin, nonactin, monactin, or from the family of crown ethers such as: dicyclohexano-18-crown-6, dibenzo-18-crown-6, naphtho-15-crown-5, benzo-15-crown-5 including (hexanoyloxymethyl)benzo-15-crown-5, 2-dodecyl-2-methyl-1,3-propanediyl bis[N-[5′-nitro(benzo-15-crown-5)-4′-yl]carba mate] and dibenzo-30-crown-10.

The formulation used to implement the method can comprise:
25% to 75% by mass of polymer,
25% to 75% by mass of plasticiser,
0.1% to 0.5% by mass of ion exchanger,
0.5% to 2.5% by mass of ionophore.

In an advantageous manner, the molar ratio of the ion exchanger to the ionophore ranges from 20% to 80%.

In step b), the formulation can be deposited by screen printing. Such a technique makes it possible to reduce the costs of production compared to the dropwise deposition.

The evaporation of the solvent in step c) leads to the formation of a solid membrane. Advantageously, annealing is carried out at a temperature ranging from 35° C. to 130° C. to promote the evaporation of the solvent. The membrane has a thickness ranging for example from 5 to 50 μm.

At the end of the method, the membrane contains traces of solvent. It preferably contains 0.1% to 5% by mass of solvent, for example 0.1% to 2% by mass.

Advantageously, the method described above is used for producing the ISE polymer membrane 10 of a working electrode.

The working electrode is formed on a substrate 20, for example made of glass.

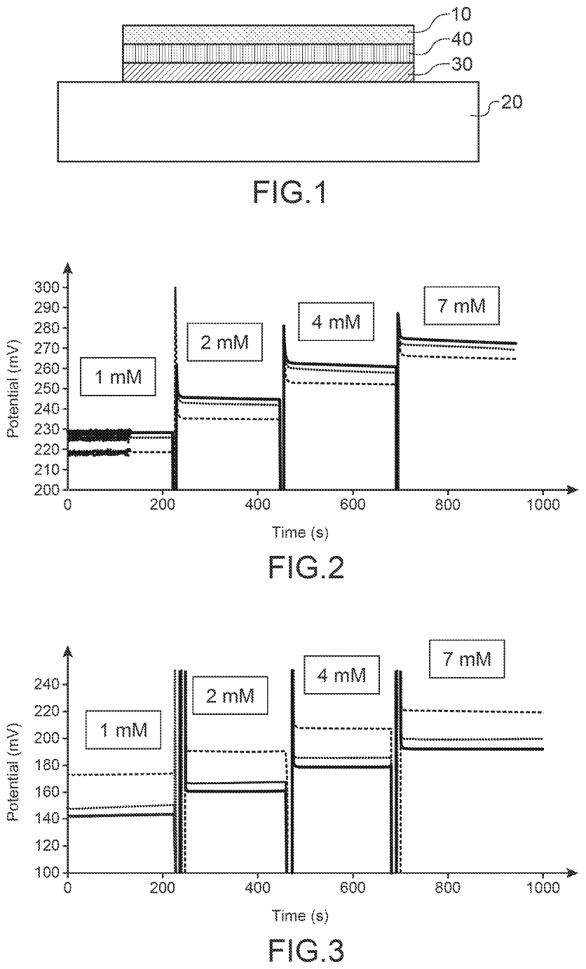

The electrode comprises successively, from the substrate upwards in the stack (FIG. 1):
a current collector 30,
a transducer 40 for converting the activity of a dissolved ion into electrical potential,
the ion-selective polymer membrane 10 for transporting the target ion from the solution to the transducer.

The current collector 30 is for example in the form of electrically conductive tracks. The current collector 30 is advantageously made of metal, in particular platinum. The collector has a thickness ranging from 1 to 1000 nm for example.

The transducer 40 is, preferably, made from a carbon material. For example, it is a mixture of graphite and carbon black. The layer forming the transducer can be obtained by preparing a solution containing one or more materials in particulate and/or lamellar form, a solvent and optionally a binder, then depositing the solution. The solvent is advantageously the same as the one used to make the polymer membrane of the electrode. The transducer 40 has a thickness ranging from 1 to 10 μm for example.

Such a working electrode 10 is advantageously arranged in an electrochemical sensor further comprising a reference electrode. The reference electrode is advantageously an Ag/AgCl electrode. According to another embodiment, the sensor could also comprise a counter electrode.

The resulting electrochemical sensor is used to determine the analyte concentration of a fluid by measuring the potential difference between the reference electrode and the working electrode.

The sensor can be used to analyse fluid samples of different volumes. Preferably, the sensor can be used to analyse a drop of fluid, in particular a drop of body fluid, for example a drop of blood. A drop is defined as a volume of fluid ranging from 4 μL to 100 μL.

The electrochemical sensor can also be used in combination with an optical sensor in an analysis device. These sensors can be positioned in the same analysis chamber or in different chambers. The electrochemical and optical measurements can be performed simultaneously or consecutively. The initiation of one of the analyses, for example, the electrochemical analysis, can depend on the result obtained for the other analysis, for example for optical analysis.

The analysis device can be capable of detecting one or more analytes.

### Illustrative and Non-Limiting Examples of an Embodiment

Two formulations for producing ISE membranes were prepared which are identical (in terms of percentages by mass of polymer (PU), plasticiser, ion exchanger, ionophore and final dry extract of the solution), one containing THF (referred to as CE-1) and the other containing DGMEA (referred to as INV-1).

To prepare formulations, a solution containing different constituents of the ISE membrane is heated and stirred. In the case of CE-1 a temperature of 50° C. was used and in the case of INV-1 the temperature was approximately 110° C.

Once the mixture has been made homogenous, a volume of 1.0 μl of each formulation is deposited on the surface of the transducer. The mixture is then placed overnight in an oven at 50° C.

The chips used include a reference electrode (Ag/AgCl, 5874 Dupont) and three working electrodes (i.e. ISE).

For each chip, a calibration test is carried out with 1, 2, 4 and 7 mM KCl solutions (with 100 mM NaCl). The potential is recorded for at least 3 minutes for each concentration and for each of the three working electrodes (FIGS. 2 and 3).

The data analysis is performed by applying the Nernst equation:

$$E = {E}^{0} + \frac{RT}{\text{?}} ln \frac{\text{?}}{{a}_{Red}^{y}}$$

$$\text{?} \text{indicates text missing or illegible when filed}$$

with:

R is the constant of perfect gases,

T is the temperature expressed in Kelvin,

F is Faraday's constant,

a is the chemical activity of the species, with Ox for the oxidising species and Red for the reducing species,

n is the number of electrons,

E is the measured potential,

E⁰ is obtained by linear regression from the calibration curves.

In the case of potassium, we have:

$$x = y = 1 ; n = 1 ; {a}_{Red} = 1 ; {a}_{Ok} = [ {K}^{+} ] . A 25 ° C . , \frac{RT}{F} ln 10 \sim 0 , 059 V$$

The equation then becomes:

E=E⁰+60 mV log[K⁺]·A20T

We get:

E=E⁰+58.2 mV log[K⁺]

By tracing the potential as a function of the logarithm of the potassium concentration, a straight line is obtained with a theoretical gradient of approximately 60 mV/decade.

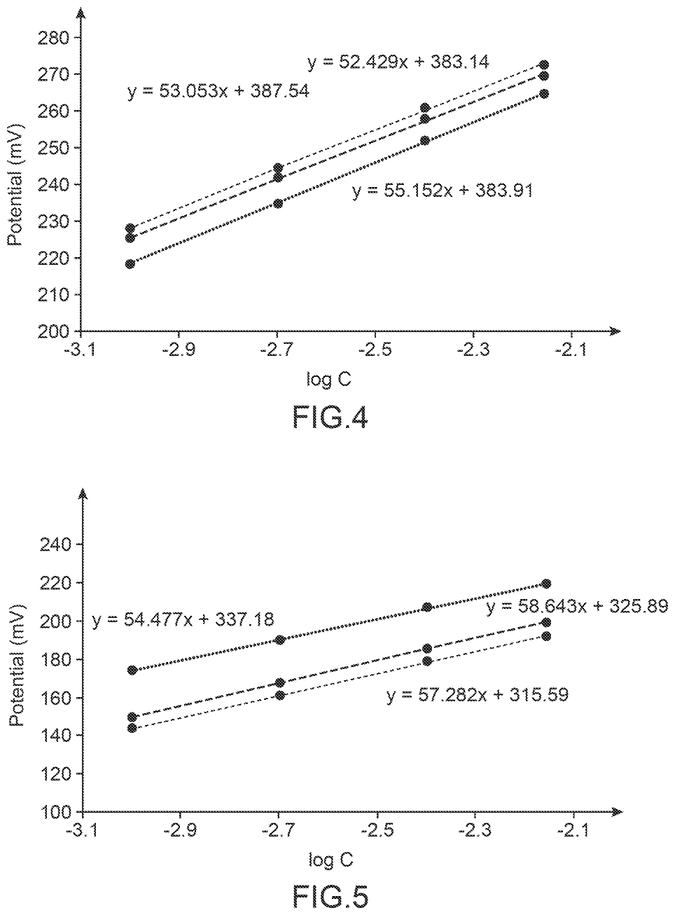

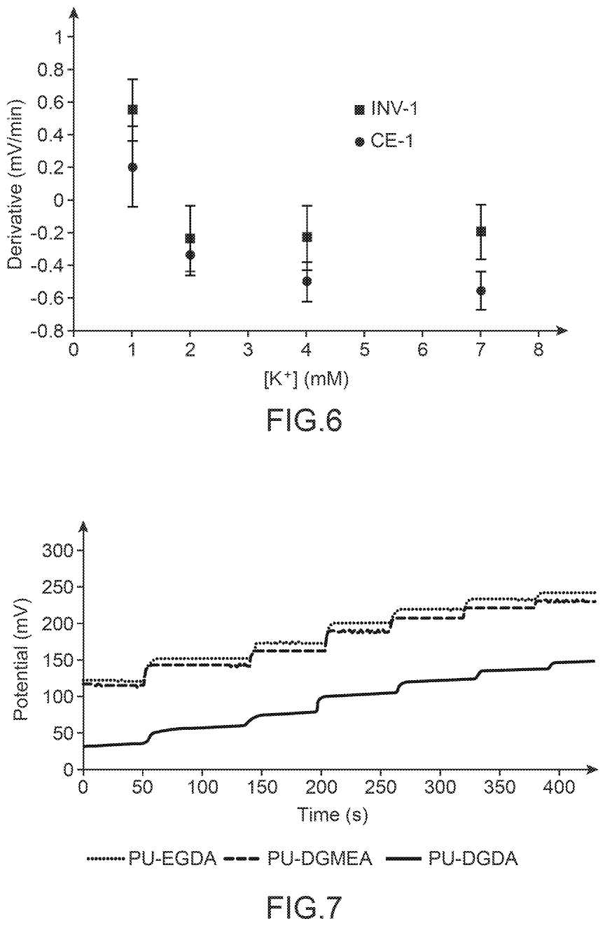

The analysis of the curves obtained (FIGS. 3 and 4) makes it possible to extract different parameters given in the following table: the gradient (selectivity), R² (coefficient of linear regression) and E°. The values of the gradient and E° correspond to the mean values and are given with standard deviations.

| | INV-1 | CE-1 |
|---|---|---|
| Gradient (mV/decade) | 56.8 ± 2.1 | 53.5 ± 1.4 |
| R² | 1.000 | 0.999 |
| E⁰ (mV) | 326 ± 11 | 385 ± 2 |

FIG. 5 represents the derivatives of different measurements. Over almost the whole range of concentration used (except 1 mM), CE-1 has a higher potential derivative than INV-1. This is translated by a less stable behaviour of the membrane when slightly higher concentrations of K⁺ are used (typical of the concentration of potassium ions in human blood).

The results show a better electrochemical response for the membranes prepared from the INV-1 formulation. The sensitivities are higher and the linear regression coefficient slightly higher. The stability of the sensor (inversely proportional to the derivative) is also better.

In another embodiment, three working electrodes containing a PU-based membrane were prepared. The solvent used to produce the first electrode is DGMEA, for the second electrode it is EGDA and for the third electrode it is DGDA. The electrodes are immersed in a solution, stirred, then the concentration of analyte is measured. This mode of measurement is different from the mode of measurement used statically on a chip. The concentration of potassium increases progressively in the solution by addition (FIG. 7).

The different results are shown in the following table:

| | PU-DGMEA | PU-EGDA | PU-DGDA |
|---|---|---|---|
| Gradient (mV/decade) | 50.1 | 51.2 | 50.6 |
| R² | 0.998 | 0.999 | 0.994 |
| E⁰ (mV) | 341 | 355 | 257 |

The three electrodes have good electrochemical performances.

What is claimed is:

1.-13. (canceled)

14. A method for producing a polymer membrane for the potentiometric detection of an analyte, the method comprising the following successive steps:
providing a formulation comprising a dissolved polymer, an ion exchanger, an ionophore, and a solvent selected from alkylene glycol diacetates, glycol ethers and acetates thereof;
depositing the formulation on a support; and
evaporating the solvent, so as to form a polymer membrane.

15. The method according to claim 14, wherein the solvent is selected from ethylene glycol monoalkyl ether acetates, diethylene glycol monoalkyl ether acetates, ethylene glycol dialkyl ether acetates, and diethylene glycol dialkyl ether acetates.

16. The method according to claim 15, wherein the solvent is diethylene glycol monoethyl ether acetate.

17. The method according to claim 14, wherein the solvent is selected from ethylene glycol diacetate and diethylene glycol diacetate.

18. The method according to claim 14, wherein the formulation comprises an additional solvent, whereby a mixture of solvents is formed, the additional solvent being less than 50% by volume of the mixture of solvents.

19. The method according to claim 14, wherein the ionophore and ion exchanger are selective for potassium ions.

20. The method according to claim 14, wherein the polymer is selected from vinyl polymers, polysiloxanes, polyurethanes, polystyrenes, cellulose acetate, poly(vinylpyrrolidinone) copolymers and (meth)acrylates.

21. The method according to claim 20, wherein the polymer is selected from poly(vinyl pyrrolidone-co-vinyl acetate), decyl methacrylate-hexanediol dimethacrylate and polymethylmethacrylate.

22. The method according to claim 14, wherein the polymer is a polyurethane.

23. The method according to claim 14, wherein the formulation further comprises a plasticiser.

24. The method according to claim 14, wherein the support is a transducer.

25. A formulation for producing a polymer membrane for the potentiometric detection of an analyte, the formulation comprising a dissolved polymer, an ion exchanger, an ionophore, and a solvent selected from glycol ethers and acetates thereof, and alkylene glycol diacetates.

26. The formulation according to claim 25, wherein the formulation comprises a plasticiser.

27. A polymer membrane for the potentiometric detection of an analyte, the polymer membrane obtained by the method according to claim 14, a polymer, an ion exchanger, an ionophore and traces of a solvent selected from glycol ethers and acetates thereof, and alkylene glycol diacetates.

28. The polymer membrane according to claim 27, wherein the polymer membrane further comprises a plasticiser.

29. A method for producing a working electrode comprising the following successive steps:
providing a formulation comprising a dissolved polymer, an ion exchanger, an ionophore, and a solvent selected from glycol ethers and acetates thereof, and alkylene glycol diacetates;
providing a substrate, covered successively by a current collector and by a transducer;
depositing the formulation on the transducer; and
evaporating the solvent to form a polymer membrane.

30. The method according to claim 29, wherein the transducer is obtained by depositing on the current collector a solution containing a carbon material and a solvent selected from glycol ethers and acetates thereof and alkylene glycol diacetates.

31. The method according to claim 29, wherein the solvent of the formulation and the solvent of the solution are identical.

32. The method according to claim 29, wherein the formulation further comprises a plasticiser.
